(19) United States
(12) Patent Application Publication
(10) Pub. No.: US 2023/0371531 A1
(43) Pub. Date: Nov. 23, 2023

(54) DEPILATING MACHINE WITH OPTIMIZED STRUCTURE

(71) Applicant: Dezhou Ouzhan International Trade Co., Ltd., Dezhou (CN)

(72) Inventor: Chunxiao Wang, Dezhou (CN)

(21) Appl. No.: 18/137,486

(22) Filed: Apr. 21, 2023

(30) Foreign Application Priority Data
May 23, 2022 (CN) 202221243709.0

(51) Int. Cl. A22C 21/02

(52) U.S. Cl. CPC A22C 21/026

(57) ABSTRACT

The present invention discloses a depilating machine with an optimized structure, which comprises a barrel, a supporting part for supporting the barrel, a turntable located in the barrel, a driving device for driving the turntable to rotate and a depilating stick, wherein the depilating stick is arranged inside the barrel; the barrel is divided into at least two connecting blocks connected end to end in the longitudinal direction, and the lower ends of the connecting blocks are detachably connected with the supporting part.

### TECHNICAL FIELD

The present invention relates to the technical field of poultry depilation, in particular to a depilating machine with an optimized structure.

### BACKGROUND

In order to facilitate the depilation of poultry, a large number of depilation machines have been used in the prior art to replace the original manual depilation, which greatly improves the depilation efficiency. In the prior art, however, most depilators adopt an integrated structure. For example, U.S. Pat. No. 4,267,713 discloses a machine for removing the hair from animal hides, comprises an upwardly open vat and a horizontal perforated plate arranged in the lower part of the vat and rotationally driven on a central pivot by suitable means. The plate is provided on its surface in contact with the material to be treated with sharp edges formed on the contour of said perforations, and bounded peripherally by a fixed perforated cylinder, defining with the inner wall of the vat a coronary space ensuring the removal of the hair stripped off and projected by centrifugal force into the openings of said cylinder.

The depilating machine adopting this solution has an integrated structure with its cylinder and base, which is large in volume, requires a lot of packaging materials during packaging and a large transportation space during transportation. On the one hand, it increases the transportation cost of the depilating machine, on the other hand, it limits the transportation mode of the depilating machine and greatly reduces the user's experience.

In order to make the depilating machine more convenient in the process of packaging and transportation, a lot of attempts have been made in the prior art to reduce the volume of the depilating machine. For example, China patent No. 209768773 discloses a split depilating machine, which comprises a disc frame and a circular chassis, wherein a shaft hole is arranged in the middle of the circular chassis, and four crutch-shaped supporting legs distributed in front, back, left and right directions are arranged under the bottom of the circular chassis; the crutch-shaped supporting legs are connected with the bottom of the circular chassis in a detachable way, and a detachable cross is arranged between the crutch-shaped support legs.

In this solution, the transport volume of the depilating machine is reduced by separating the base from the barrel and disassembling the base at the same time. However, the barrel of this solution is still an integrated barrel, which still occupies a large transport space, and the transmission parts of this solution also need to be disassembled together, which is extremely inconvenient for disassembly and assembly.

Based on the above problems, it is necessary to provide a new depilating machine, which occupies less transportation space and has lower weight, and is more convenient to disassemble and use, and at the same time, it can have various transportation modes to increase the user's experience.

### SUMMARY

The present invention discloses a depilating machine with an optimized structure, which includes a barrel, a supporting part for supporting the barrel, a turntable located in the barrel and a driving device for driving the turntable to rotate, wherein the depilating machine further comprise a depilating stick arranged inside the barrel; the barrel is divided into at least two connecting blocks which are connected end to end in a longitudinal direction, and low ends of the connecting blocks are detachably connected with the supporting part.

At least one embodiment of the present invention relates to a depilating machine with an optimized structure; the supporting part includes a plurality of supporting legs, rollers are arranged on at least two supporting legs, and a connecting shaft 502 is arranged between at least two rollers.

The present invention discloses a depilating machine with an optimized structure, which includes a plurality of supporting legs, in which the lower end of the supporting leg is bent outwards to form a lateral connecting part; the end of the lateral connecting part is bent downwards to form a supporting end, and at least two supporting ends are provided with connecting pieces for mounting rollers.

### BRIEF DESCRIPTION OF DRAWINGS

In order to explain the technical solution of this application more clearly, the drawings needed in the implementation will be briefly introduced below. Obviously, the drawings described below are only some implementations of this application. For ordinary technicians in this field, other drawings can be obtained according to these drawings without creative work.

FIG. 1 is a schematic diagram of a depilating machine with an optimized structure provided by the present invention;

FIG. 2 is an explosion schematic diagram of a depilating machine (without depilating stick) with an optimized structure provided by the present invention;

FIG. 3 is a schematic diagram of the connecting block of the present invention;

FIG. 4 is a schematic diagram of the connecting ring of the present invention;

FIG. 5 is a schematic view of the supporting part of the present invention;

FIG. 6 is an explosion schematic diagram of the supporting part of the present invention;

FIG. 7 is a schematic view of the supporting leg of the present invention;

FIG. 8 is a schematic diagram of the driving device of the present invention.

In the figures:

1, Barrel; 101, Connecting block; 102, Connecting lug; 103, Connecting ring; 1031, Hoop; 104, Threaded hole; 105, Reinforcing rib; 2, Supporting part; 3, Turntable; 4, Lower chassis; 401, Latch; 402, Liquid discharge port; 403, Limit ring; 5, Supporting leg; 501, Roller; 502, Connecting shaft; 503, Lateral connecting part; 504, Supporting end; 505, Connecting plate; 6, Driving device; 601, Housing; 7, Depilating stick.

### DESCRIPTION OF EMBODIMENTS

In the following, the technical solution in the embodiment of the application will be clearly and completely described with reference to the drawings in the embodiment of the application. Obviously, the described embodiment is only a part of the embodiment of the application, but not the whole embodiment. Based on the embodiments in this application, all other embodiments obtained by ordinary technicians in this field without creative labor belong to the protection scope of this application.

Reference to “an example or “an embodiment” herein means that a particular feature, structure or characteristic described in connection with an embodiment or an embodiment can be included in at least one embodiment of this application. The appearance of this phrase in various places in the specification does not necessarily refer to the same embodiment, nor is it an independent or alternative embodiment mutually exclusive with other embodiments. It is understood explicitly and implicitly by those skilled in the art that the embodiments described herein can be combined with other embodiments.

In this specification, for the sake of convenience, words and expressions indicating orientation or positional relationship such as “middle”, “upper”, “lower”, “front”, “rear”, “vertical”, “horizontal”, “top”, “inner” and “outer” are used to illustrate the positional relationship of constituent elements with reference to the attached drawings, only for the convenience of description. The positional relationship of the constituent elements is appropriately changed according to the direction of the described constituent elements. Therefore, they are not limited to the words and expressions described in the specification, and can be replaced appropriately according to the situation.

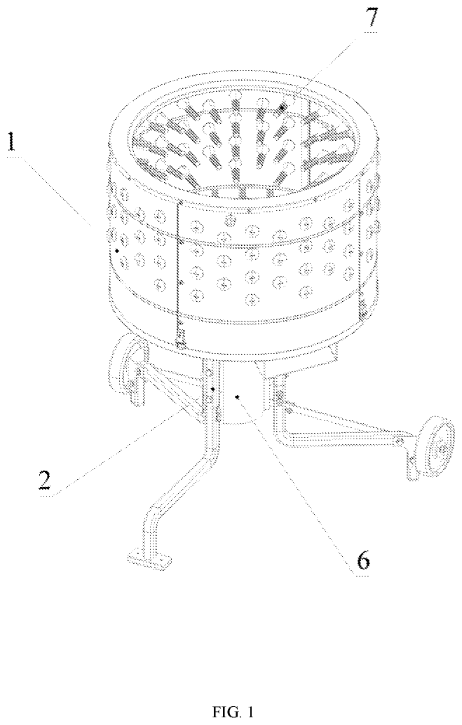

As shown in FIG. 1, a depilating machine with an optimized structure provided by the present invention includes a barrel 1, a supporting part 2, a turntable 3, a driving device 6 and a depilating stick 7.

In this embodiment, both the turntable 3 and the depilating stick 7 are arranged in the barrel 1, and the turntable 3 is driven by the driving device 6, so as to drive the poultry placed on the turntable 3 to rotate. When the poultry rotates, the feathers on the poultry are peeled off by the depilating stick 7, and the depilation effect is achieved.

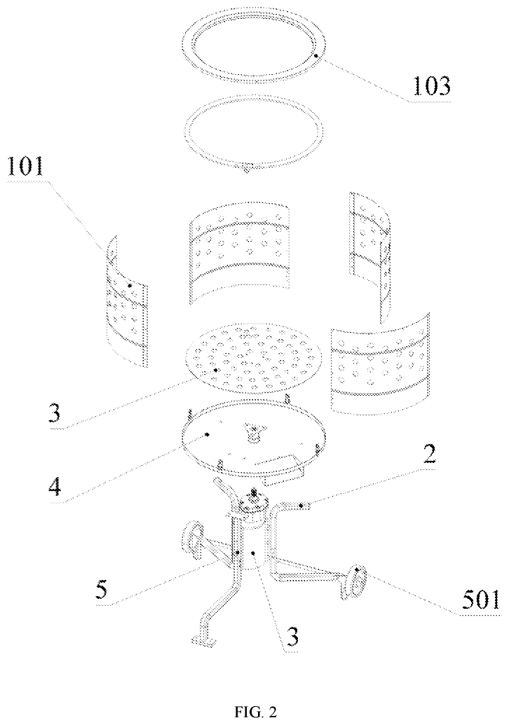

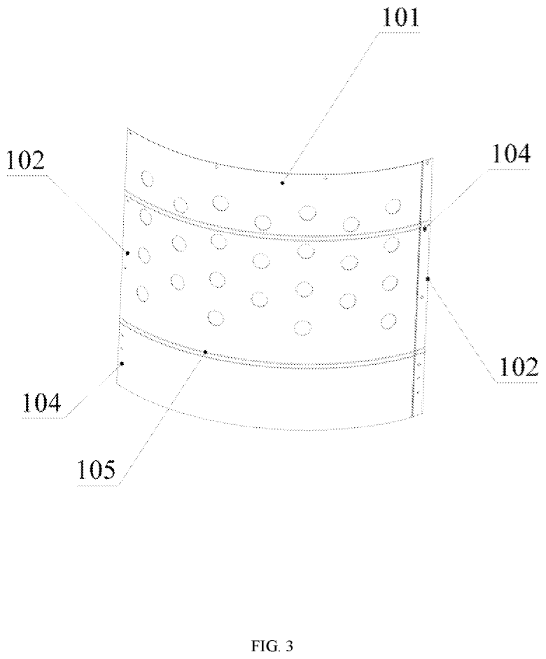

In order to reduce the transportation volume of the depilating machine without affecting the performance of the depilating machine, as a preferred embodiment of the present invention, as shown in FIGS. 2 and 3, the barrel 1 of the present invention is configured to be formed by connecting a plurality of connecting blocks 101 end to end in the longitudinal direction, and the lower ends of the connecting blocks 101 are detachably connected with the supporting part 2.

Specifically, as shown in FIG. 3, in this embodiment, the barrel 1 is configured to be formed by four connecting blocks 101 connected end to end in the longitudinal direction, and the annular profiles of the four connecting blocks are equal, and a regular circular barrel can be formed by splicing their annular profiles together.

In some embodiments, the connection blocks 101 may have different number combinations. In other embodiments, several connecting blocks 101 may also have a variety of different annular profiles.

In this embodiment, as shown in FIG. 3, two sides of the connecting block 101 are provided with connecting lugs 102 extending in the vertical direction, and the connecting lugs 102 are provided with a plurality of threaded holes 104, so that a plurality of connecting blocks 101 are fixedly connected by butting the connecting lugs 102 and then passing through the threaded holes 104 with bolts. In some embodiments, the connecting lug can also take the form of a connecting piece to fixedly connect a plurality of connecting blocks.

In some embodiments, in order to improve the sealing performance and shock absorption performance between the connecting blocks 101, a gasket (not shown in the figure) can be arranged between the connecting lugs 102, and a through hole corresponding to the threaded hole 104 is arranged on the gasket, thereby reducing the gap between the connecting blocks 101 and improving the overall sealing performance and shock absorption performance of the barrel 1.

In this embodiment, in order to increase the service strength of the barrel 1, a reinforcing rib 105 perpendicular to the connecting lug 102 is also arranged outside the connecting block 101, which can effectively increase the service strength of the barrel 1 and prolong the service life of the barrel 1. In some embodiments, a plurality of reinforcing ribs 105 may be provided.

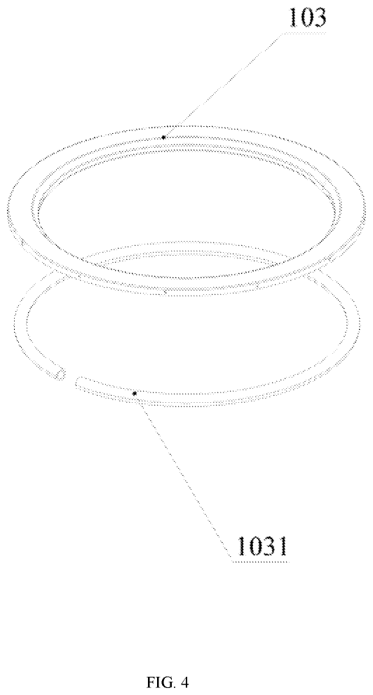

As a preferred embodiment of the present invention, in order to better fix the enclosed state of the connecting block 101, as shown in FIGS. 1, 2 and 4, the upper end of the connecting block 101 is also provided with a connecting ring 103, and the connecting ring 103 further includes a hoop 1031.

In this embodiment, the connecting ring 103 is fixedly connected with the upper end of the connecting block 101 by screws, and the hoop 1031 is arranged below the connecting ring 103. The outer contour diameter of the hoop 1031 is the same as the inner diameter of the barrel 1, so that the connection between the connecting blocks 101 in the enclosed state can be more stable, and the opening of the barrel 1 is not easy to deform during use.

In some embodiments, in order to better limit the position of the connecting block 101, a locating piece (not shown in the figure) can be arranged on the connecting ring 103, and the connecting ring 103 is fixedly connected with the connecting block 101 through the locating piece, which can also effectively increase the stability between the connecting blocks 101.

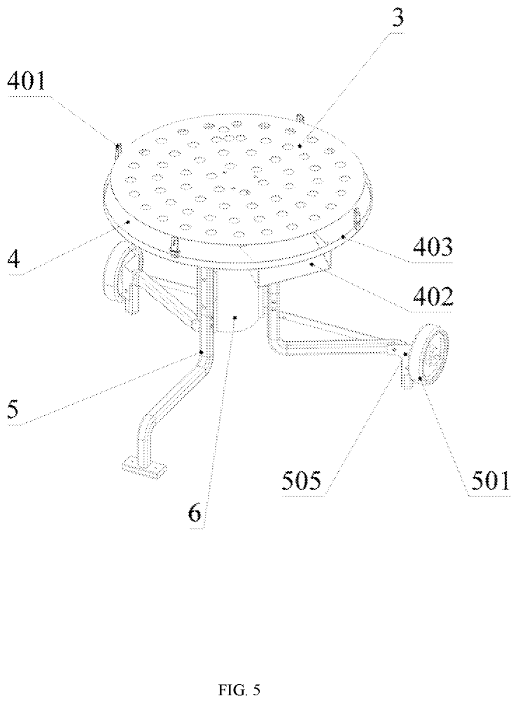

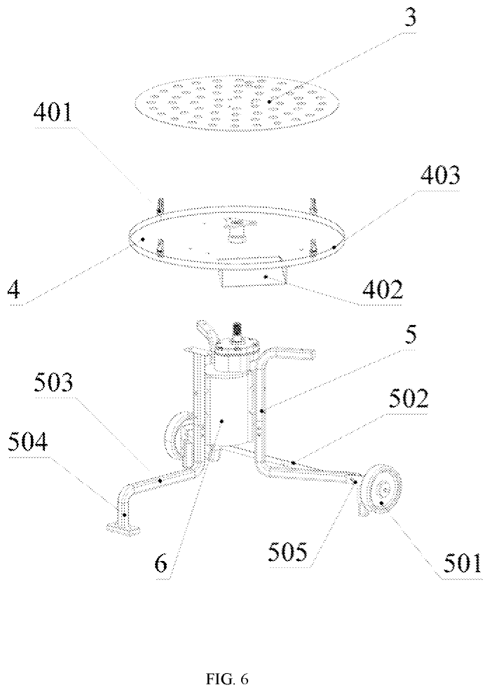

As shown in FIGS. 5 and 6, the supporting part 2 of the present invention includes a lower chassis 4, supporting legs 5 and rollers 501. Among them, a liquid passing cavity is formed between the turntable 3 and the lower chassis 4, and a liquid passing gap is formed between the turntable 3 and the edge of the barrel 1; the liquid passing gap is communicated with the liquid cavity, and the lower chassis 4 is also provided with a liquid discharge port 402 communicating with the liquid cavity.

In this embodiment, when depilation is performed in the barrel 1, both liquid and feathers can enter the liquid passing cavity through the liquid passing gap and then be discharged via the liquid discharging port 402. The lower chassis 4 is arranged below the turntable 3 and detachably connected with the connecting block 101. Specifically, the edge of the lower chassis 4 is provided with a protruding limit ring 403, the lower end of the connecting block 101 is inserted inside the limit ring 403, and the outer wall of the connecting block 101 abuts against the inner wall of the limit ring 403. A latch 401 is arranged between the limit ring 403 and the connecting block 101, and they are connected by the latch 401.

In some embodiments, the lower chassis 4 and the connecting block 101 can also be connected by threads. In other embodiments, the connection mode can also adopt connecting pieces.

As shown in FIGS. 5 and 6, the supporting part 2 also includes at least three supporting legs 5 fixed at the bottom of the lower chassis 4, and the bottoms of the supporting legs 5 are located on the same horizontal plane; rollers 501 are fixed at the lower ends of at least two supporting legs 5, and all the rollers 501 rotate in the same direction.

In this embodiment, as shown in FIGS. 5 and 6, a stable three-legged support structure is formed between three supporting legs 5, and rollers 501 are arranged on two adjacent supporting legs 5. When moving is needed, the rollers 501 are directly used to move, which greatly reduces the limitation of transportation mode.

As a preferred embodiment of the present invention, a connecting shaft 502 is also arranged between two rollers 501, and the bottom of the roller 501 is foldably located above the bottom of the supporting leg 5, that is, when the machine is normally placed and used, the rollers 501 can be folded upward without contacting with the ground, but contact with the ground through the bottom of the three supporting legs 5 to play a supporting role.

When it is necessary to move the depilating machine, it is directly pushed to be slightly inclined, so that the rollers 501 can land on the ground, and the rollers 501 can assist the depilating machine to move, which makes the position change of the depilating machine more convenient. At the same time, the arrangement of the connecting shaft 502 can also make the two rollers 501 rotate synchronously, further improving the moving effect of the depilating machine. The connecting shaft 502 can also be divided into multiple sections, and adjacent sections can be connected by screws and other things, which further reduces the length after disassembly and is convenient for transportation.

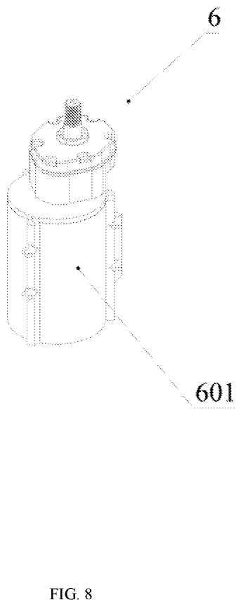

As shown in FIG. 8, the driving device of the present invention includes a housing 601, a motor installed in the housing 601, a gear set drivingly connected with the output shaft of the motor, and a rotating shaft driven by the gear set. The gear set can be composed of a plurality of gears engaged with each other, and the rotating speed of the rotating shaft can be adjusted through the gear ratio. In some embodiments, the gear set can also be driven by pulleys or other transmission modes, as long as the rotation speed of the rotating shaft can be controlled.

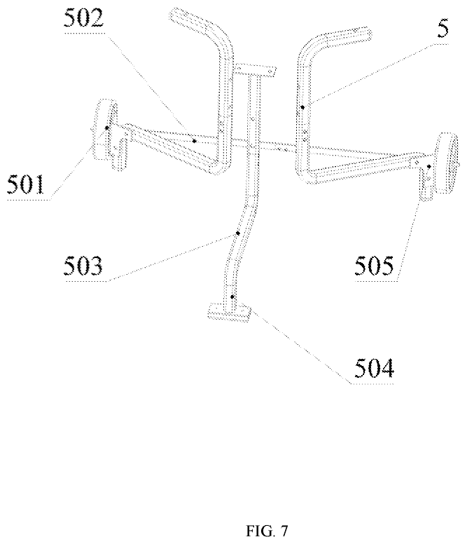

The rotating shaft penetrates through the lower chassis 4 and is fixedly connected with the turntable 3, the rotating shaft is rotatably connected with the lower chassis 4, and the housing 601 is connected with the upper end of the supporting leg 5. As a preferred embodiment of the present invention (see FIG. 7), the lower end of the supporting leg 5 is bent outward to form a lateral connecting part 503, and the end of the lateral connecting part 503 is bent downward to form a supporting end 504. The supporting ends 504 of two of the supporting legs 5 are both provided with a connection plate 505 for mounting the roller 501, that is, the upper ends of the supporting legs 5 are connected with the eccentric position of the lower chassis 4, and the housing 601 can be fixed on the upper ends of the supporting legs 5 by screws and the like. The lower end of the supporting leg 5 extends outward to form a lateral connecting part 503, which can extend to the edge of the turntable 3 or extend outside the turntable 3 to improve the stability of the support.

A connecting plate 505 is used to facilitate the installation of the roller 501, make the rotation direction of the roller 501 consistent, and facilitate the installation of the connecting shaft 502. In an embodiment, the installation position of the connecting plate 505 can be adjusted according to the actual situation, as long as the roller 501 can be stably fixed, and the rollers 501 can be off the ground when the depilating machine is in normal use, and meanwhile the rollers can be slightly inclined to land when the machine is moving. The supporting leg 5 can also be divided into multiple sections that are connected with each other by screws and the like, so as to further improve the transportation convenience.

When the depilating machine provided by the present invention is used, the connecting blocks 101 are assembled to form an annular barrel 1, and then the barrel 1 is fixed on the supporting part 2. The driving device drives the turntable 3 to rotate, so that the poultry located on the turntable 3 rotates together with the turntable 3, and the feathers of the poultry are detached by the depilating stick. Under the premise of not reducing the performance of the depilating machine, this arrangement can split the depilating machine into multiple parts, thus reducing the size of the depilating machine, and at the same time, it can be packaged and transported in multiple parts, which can also reduce the transportation burden, thus effectively reducing the transportation difficulty and cost.

The technical means disclosed in the solution of the present invention are not limited to the technical means disclosed in the above embodiments, but also include the technical solution composed of any combination of the above technical features. It should be pointed out that for those skilled in the art, several improvements and embellishments can be made without departing from the principle of the present invention, and these improvements and embellishments are also regarded as the protection scope of the present invention.

What is claimed is:

1. A depilating machine with an optimized structure, comprising a barrel, a supporting part for supporting the barrel, a turntable located in the barrel and a driving device for driving the turntable to rotate, wherein
the depilating machine further comprise a depilating stick arranged inside the barrel, wherein the barrel is divided into at least two connecting blocks which are connected end to end in a longitudinal direction, and low ends of the connecting blocks are detachably connected with the supporting part.

2. The depilating machine with an optimized structure according to claim 1, wherein the connecting block is provided with a connecting lug which extends in a vertical direction and is provided with a threaded hole.

3. The depilating machine with an optimized structure according to claim 2, further comprising a connecting ring, and a top of the barrel is fixedly connected with the connecting ring by screws.

4. The depilating machine with an optimized structure according to claim 3, wherein a reinforcing rib is arranged on the connecting block, and an extending direction of the reinforcing rib is perpendicular to an extending direction of the connecting lug.

5. The depilating machine with an optimized structure according to claim 1, wherein the supporting part comprises a lower chassis, which is arranged below the turntable and detachably connected with the connecting block.

6. The depilating machine with an optimized structure according to claim 5, wherein a liquid passing cavity is formed between the turntable and the lower chassis, and a liquid passing gap is formed between the turntable and the barrel; the liquid passing gap is communicated with the liquid passing cavity, and the lower chassis is further provided with a liquid discharge port communicating with the liquid passing cavity.

7. The depilating machine with an optimized structure according to claim 6, wherein the supporting part comprises a plurality of supporting legs and rollers; one end of the supporting leg is fixedly connected with a bottom of the lower chassis, and the other end is fixedly connected with the rollers; and bottoms of the supporting legs are located on a same horizontal plane.

8. The depilating machine with an optimized structure according to claim 7, wherein there are three supporting legs, and at least two of the supporting legs are provided with rollers; and a connecting shaft is arranged between at least two of the rollers.

9. The depilating machine with an optimized structure according to claim 8, wherein the driving device comprises a housing, a motor installed in the housing, a gear set in transmission connection with an output shaft of the motor, and a rotating shaft driven by the gear set, wherein the rotating shaft passes through the lower chassis and is fixedly connected with the turntable, and is in transmission connection with the lower chassis.

10. A structure-optimized depilating machine according to claim 9, wherein the housing is connected with an upper end of the supporting leg, and a lower end of the supporting leg is bent outward to form a lateral connecting part; an end of the lateral connecting part is bent downward to form a supporting end, and the supporting ends of at least two supporting legs are provided with connecting pieces for mounting the rollers.
